(19) United States
(12) Patent Application Publication
(10) Pub. No.: US 2005/0165697 A1
(43) Pub. Date: Jul. 28, 2005

(54) Method of confirming transactions through mobile wireless devices during reselling and distribution of products and services

(76) Inventors: Dinesh Kashinath Anvekar, Bangalore (IN); Bhaskarpillai Gopinath, Topanga, CA (US); Atul Gupta, Los Angeles, CA (US)

Correspondence Address: John T. Peoples, 14 Blue Jay Court, Warren, NJ, 07059, US

(21) Appl. No.: 11/004,031

(22) Filed: Dec. 4, 2004

Related U.S. Application Data
(60) Provisional application No. 60/539,747, filed on Jan. 27, 2004.

(51) Int. Cl. G06F 17/60

(52) U.S. Cl. 705/65

(57) ABSTRACT

Providing proof of purchase via a mobile phone or other portable device by a seller to an anonymous buyer who preferably has a mobile phone-camera.

### CROSS-REFERENCE TO A RELATED APPLICATION

This application is a non-provisional application of provisional application Ser. No. 60/539,747 filed Jan. 27, 2004.

### BACKGROUND OF THE DISCLOSURE

1. Field of Invention

The present invention relates to the field of electronic commerce, particularly financial transactions carried out by electronic means, such as the buying or selling of products/services using mobile wireless electronic means. More particularly, the present invention relates to providing proof of purchase via a mobile phone or other portable device by a seller to an anonymous buyer who preferably has a mobile phone-camera.

2. Description of the Background Art

In recent times many products and services can be purchased by users equipped with mobile wireless phones that have the capability of data communication with servers connected to the Internet. As an example, mobile game packages and services can be directly ordered from game service providers by using web-enabled mobile phones. One particular business model for selling of products and services involves mobile sales persons who can transact with buyers in field and complete sales by using their mobile phones as the principal means of effecting transactions with a web-based sales site. A basic problem in such sales is the requirement for providing the purchaser with a confirmation and proof of purchase in terms of a receipt or transaction identifier (ID). Keeping this problem in view, solutions to providing a confirmation to the purchaser are the subject matter of the present invention.

Many inventions involving methods and systems for completing transactions with wireless phones have been disclosed in the prior art. For example, U.S. Patent applications 20030149662, 20020023027, 20030163384, and U.S. Pat. Nos. 6,512,919 and 6,335,753 are illustrative of such prior art. However, none of the prior art invention involves the selling of products and services by a vendor equipped with a wireless phone and the capturing of receipt information so the purchaser can confirm purchases.

The subject matter of U.S. Patent Application 20030149662 provides apparatus, systems and methods to wirelessly pay for purchases, electronically interface with financial accounting systems, and electronically record and wirelessly communicate authorization transactions using wireless communication devices. The invention also provides means for making service and/or sale service charge payments, where the amount of the transaction is for a small amount of money.

In the U.S. Patent Application 20020023027, a method of providing a purchaser with a confirmation of a transaction that includes providing the purchaser with an electronic machine-readable image such as bar code is described. The machine-readable image on the display screen of a hand-held device may be used by the user for obtaining products and services after verification through a transaction validation device that preferably includes an optical scanner for reading the barcode image from the display.

A disclosure wherein receipt data corresponding to a purchase of predetermined goods or a service are downloaded to a mobile handset and displayed as a bar code is embodied in the U.S. patent application 20030163384. The receipt data from the handset is received by a vending delivery station and the provision of the purchased goods or service to the customer is enabled.

In the U.S. Pat. No. 6,512,919, an electronic shopping system that facilitates purchase transactions via a wireless videophone is described. An integral digital camera attached to the wireless telephone is used to facilitate the selection of items to be purchased. The digital camera is controlled via a purchase transaction program to function as a bar code or product icon image capture device. The bar or icon code image is translated into an appropriate item identifier by a character or pattern recognition software.

The use of a digital camera to capture a received video image, and transmitting the captured digital image to a microprocessor in a wireless communication video telephone system is described in the U.S. Pat. No. 6,335,753. While image capture using a digital camera in association with a video telephone is involved in this invention, there is no reference to electronic commerce involving a vendor, customers and an E-commerce server.

### SUMMARY OF THE INVENTION

In accordance with one broad method aspect of the present invention, a method for confirming the purchase of a commodity such as a product or service by an anonymous customer from an e-commerce provider via an Internet server, the purchase being transacted between the customer and a vendor having access to the server, the vendor possessing a supply of pre-printed receipts each with a unique transaction identifier and the vendor having access to the e-commerce server via an web-enabled mobile phone with a visual display, includes: (a) upon payment by the customer of a purchase price for the commodity to the vendor: transmitting to the server by the vendor, via the mobile phone, both vendor account information and purchase information including the commodity and the unique transaction identifier from one of the pre-printed receipts corresponding to the purchase price; and transmitting from the server sale confirmation information to the mobile phone for display on the visual display; and (b) delivering by the vendor to the customer the pre-printed receipt corresponding to the transaction identifier so that the pre-printed receipt with the transaction identifier may subsequently be used by the customer for delivery of the commodity from the provider.

In accordance with another broad method aspect of the present invention, a method for confirming the purchase of a commodity such as a product or service by an anonymous customer from an e-commerce provider via an Internet server, the purchase being transacted between the customer and a vendor having access to the server via an web-enabled mobile phone with a visual display, includes; (a) upon the customer paying a purchase price for the commodity to the vendor, transmitting to the server by the vendor, via the mobile phone, both vendor account information and purchase information including the commodity and the purchase price; (b) confirming by the server the sale of the commodity by the vendor using the vendor account information and the purchase information; (c) sending sale confirmation information to the vendor from the server via the mobile phone for display on the visual display; and (d) capturing the sale confirmation information on the visual display using a camera.

### BRIEF DESCRIPTION OF THE DRAWINGS

A more complete understanding of the present invention may be obtained from consideration of the following description in conjunction with the drawings in which:

FIG. 1 is a block diagram of a preferred embodiment of the present invention wherein the vendor of a commodity such as a product or service is supplied with pre-printed receipts each having a unique transaction identifier;

FIG. 2 is a flow diagram depicts the process for controlling the devices depicted in FIG. 1 so as to confirm the purchase of a commodity by a customer;

FIG. 3 is a block diagram of a preferred embodiment of the present invention wherein the vendor of a commodity supplies purchase information to the customer via a visual display on a web-enabled mobile phone and a copy of the display is captured by a camera controlled by the customer;

FIG. 4 is a flow diagram depicts the process for controlling the devices depicted in FIG. 3 so as to confirm the purchase of a commodity by a customer;

FIG. 5 is a block diagram of a preferred embodiment of the present invention wherein the vendor of a commodity supplies purchase information to the customer via a visual display on a web-enabled mobile phone and a camera controlled by the vendor captures a copy of the display and a hard-copy is printed for the customer;

FIG. 6 is a flow diagram depicts the process for controlling the devices depicted in FIG. 5 so as to confirm the purchase of a commodity by a customer.

To facilitate understanding, identical reference numerals have been used, where possible, to designate identical elements that are common to the figures.

### DETAILED DESCRIPTION

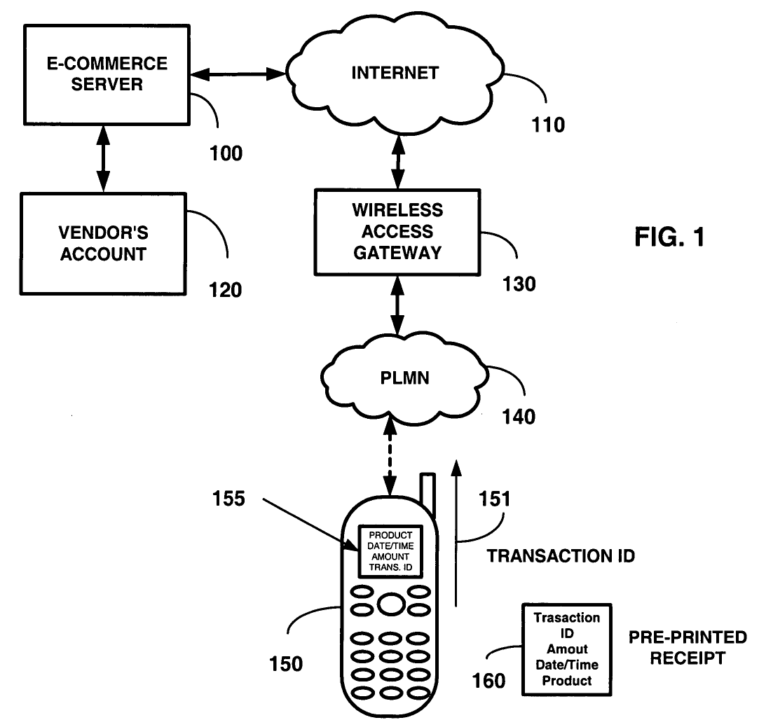

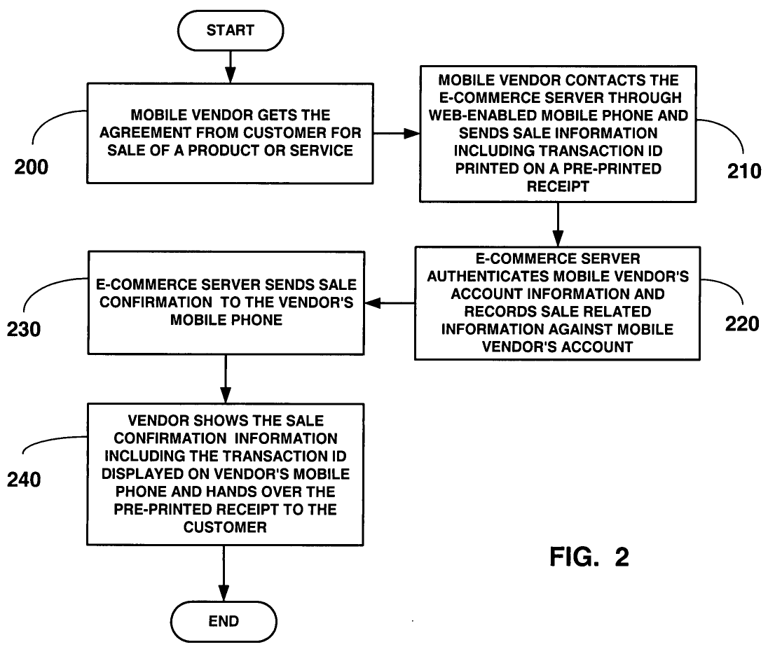

I. One preferred embodiment of the invention is shown in high-level block diagram form in FIG. 1. According to this aspect of the present invention, the vendor carries pre-printed receipts. Each of the receipts has a unique transaction identifier (ID) and an amount associated with it. All of the receipts are initially registered against the vendor's account with an e-commerce provider via an e-commerce Internet server; the receipts are to be associated with the sale of a commodity such as a product or service from the service provider. The transaction steps as per this aspect of the invention are shown in the flowchart given in FIG. 2, including the following processes:

Process 200: A vendor having an account with an e-commerce provider finalizes a deal for sale of the commodity and obtains an agreement from the customer to proceed with completing the transaction.

Process 210: The mobile vendor uses his/her web-enabled mobile phone 150 to contact the e-commerce server 100 of the provider and sends, as depicted by upwardly directed path 151: (a) vendor account identifier information; and (b) sale information as depicted on display 155 including a transaction identifier (ID) printed on a pre-printed receipt 160—also shown as TRANS. ID on display 155. The sale-related information including the transaction identifier sent by the vendor reaches the e-commerce server 100 through public land mobile network (PLMN) 140, wireless access gateway 130, and the Internet 110.

Process 220: The e-commerce server 100 authenticates mobile vendor's account information and registers the sale-related information against mobile vendor's account 120.

Process 230: The e-commerce server 100 sends sale confirmation information to the vendor's mobile phone 150. The sale confirmation information reaches the vendor's mobile phone through the Internet 110, wireless access gateway 130, and PLMN 140.

Process 240: The vendor shows the sale confirmation information 155 including the transaction identifier displayed on vendor's mobile phone 150 and hands over the pre-printed receipt 160 to the customer. The customer can then use the transaction ID to obtain the sale-related commodity from the provider through means such as a mobile phone or Internet connected computer.

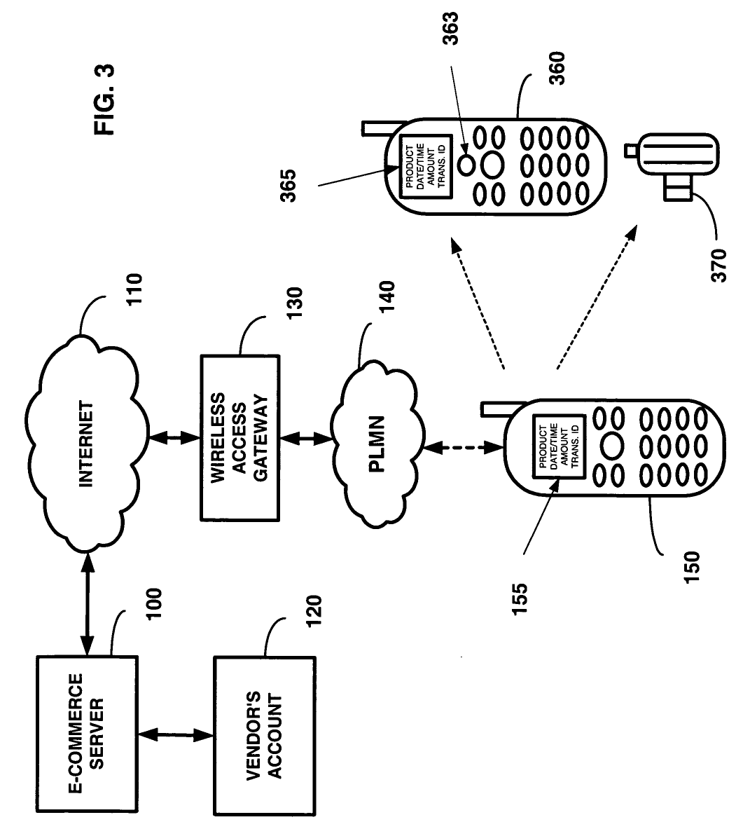

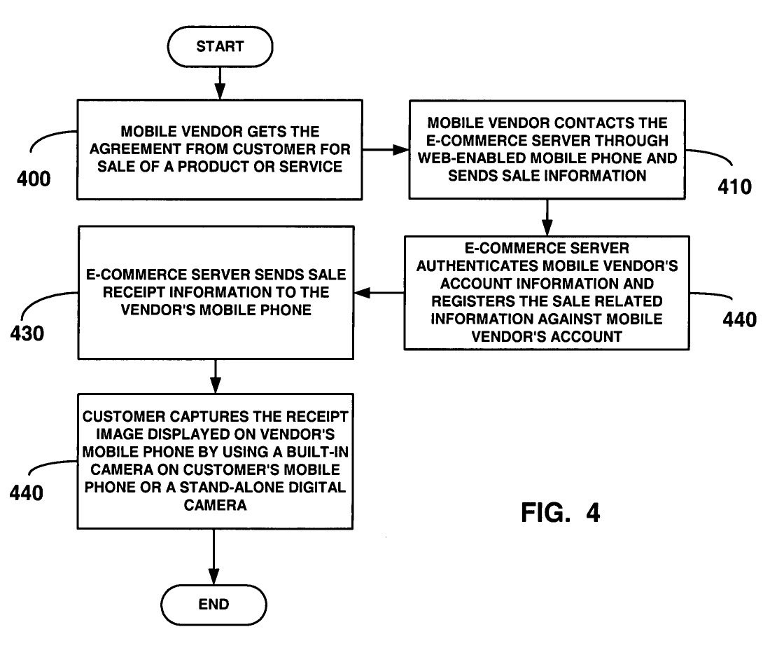

II. A schematic representation of a second aspect of the invention is shown in FIG. 3, and flowchart giving the major steps in completing a mobile phone based transaction is given in FIG. 4, including the following processes:

Process 400: A vendor having an account with the e-commerce provider finalizes a deal for sale of a product or service and obtains an agreement from the customer to proceed with completing the transaction.

Process 410: The mobile vendor uses his/her web-enabled mobile phone 150 to contact the e-commerce server 100 of the provider and sends (a) vendor account identifier information; and (b) sale information. The sale-related information sent by the vendor reaches the e-commerce server 100 through public land mobile network (PLMN) 140, wireless access gateway 130, and the Internet 110.

Process 420: The e-commerce server 100 authenticates mobile vendor's account information and registers the sale related information against mobile vendor's account 120.

Process 430: The e-commerce server 100 sends transaction receipt information to the vendor's mobile phone 150. The receipt information includes details such as product/service details, transaction identifier, vendor identification, sale date, sale amount, and optionally, the customer's identification. The transaction receipt information reaches the vendor's mobile phone through the Internet 110, wireless access gateway 130, and PLMN 140. The transaction receipt 155 is displayed on the vendor's mobile phone 150.

Process 440: The customer captures an image 365 of the transaction receipt 155 displayed on vendor's mobile phone 150 by using a built-in camera 363 on the customer's mobile phone 360 or a stand-alone digital camera 370.

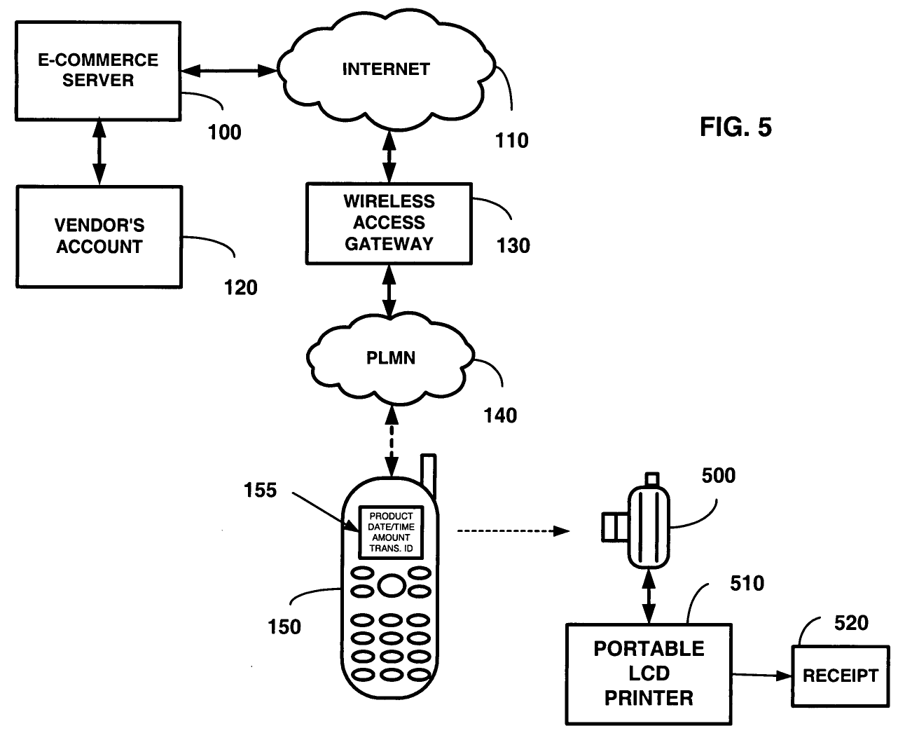

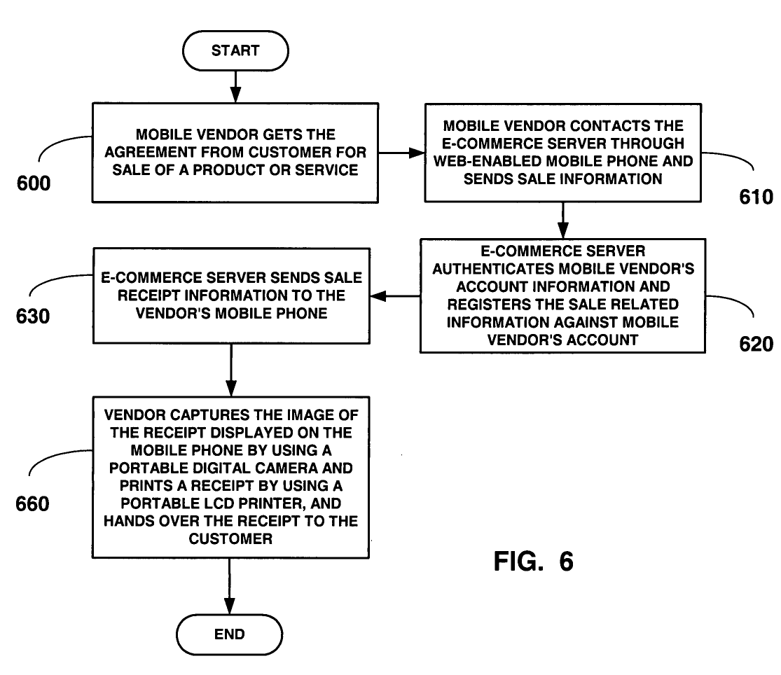

III. In yet another aspect of the invention, the vendor generates a receipt by using a portable digital camera and a portable printer. A schematic diagram for this aspect of the invention is shown in FIG. 5, and the corresponding flowchart is given in FIG. 6, including the following processes:

Process 600: A vendor having an account with the e-commerce provider finalizes a deal for sale of a product or service and obtains an agreement from the customer to proceed with completing the transaction.

Process 610: The mobile vendor uses his web-enabled mobile phone 150 to contact the e-commerce server 100 of the provider and sends (a) vendor account identifier information; and (b) sale information. The sale related information sent by the vendor reaches the e-commerce server 100 through public land mobile network (PLMN) 140, wireless access gateway 130, and the Internet 110.

Process 620: The e-commerce server 100 authenticates mobile vendor's account information and registers the sale related information against mobile vendor's account 120.

Process 630: The e-commerce server 100 sends transaction receipt information to the vendor's mobile phone 150. The receipt information includes details such as product/service details, transaction identifier, vendor identification, sale date, sale amount, and optionally, the customer's identification. The transaction receipt information reaches the vendor's mobile phone through the Internet 110, wireless access gateway 130, and PLMN 140. The transaction receipt 155 is displayed on the vendor's mobile phone 150.

Process 640: The vendor captures an image of the transaction receipt 155 displayed on vendor's mobile phone 150 by using a portable digital camera 500 and prints a receipt 520 by using a portable LCD printer 510, and hands over the receipt 520 to the customer.

As the sale transactions are carried out by vendors using their mobile phones and all transactions are recorded against the accounts of vendors in the servers, business processes of this invention are easily adaptable to multi-level marketing systems, and accounts of selling agents (vendors) can be maintained in a hierarchical manner to distribute commissions associated with the sales.

Although the embodiments of the present invention have been shown and described in detail herein, those skilled in the art can readily devise many other varied embodiments that still incorporate these teachings. Thus, the previous description merely illustrates the principles of the invention. It will thus be appreciated that those with ordinary skill in the art will be able to devise various arrangements, which although not explicitly described or shown herein, embody principles of the invention and are included within its spirit and scope. Furthermore, all examples and conditional language recited herein are principally intended expressly to be only for pedagogical purposes to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, that is, any elements developed that perform the function, regardless of structure.

In addition, it will be appreciated by those with ordinary skill in the art that the block diagrams herein represent conceptual views of illustrative circuitry, equipment, and systems embodying the principles of the invention.

1. A method for confirming the purchase of a commodity such as a product or service by an anonymous customer from an e-commerce provider via an Internet server, the purchase being transacted between the customer and a vendor having access to the server, the vendor possessing a supply of pre-printed receipts each with a unique transaction identifier and the vendor having access to the e-commerce server via an web-enabled mobile phone with a visual display, the method comprising
upon payment by the customer of a purchase price for the commodity to the vendor: transmitting to the server by the vendor, via the mobile phone, both vendor account information and purchase information including the commodity and the unique transaction identifier from one of the pre-printed receipts corresponding to the purchase price; and transmitting from the server sale confirmation information to the mobile phone for display on the visual display, and
delivering by the vendor to the customer the pre-printed receipt corresponding to the transaction identifier so that the pre-printed receipt with the transaction identifier may subsequently be used by the customer for delivery of the commodity from the provider.

2. A method for confirming the purchase of a commodity such as a product or service by an anonymous customer from an e-commerce provider via an Internet server, the purchase being transacted between the customer and a vendor having access to the server, the vendor possessing a supply of pre-printed receipts each with a unique transaction identifier and the vendor having access to the e-commerce server via an web-enabled mobile phone with a visual display, the method comprising
upon payment by the customer of a purchase price for the commodity to the vendor, transmitting to the server by the vendor, via the mobile phone, both vendor account information and purchase information including the commodity and the unique transaction identifier from one of the pre-printed receipts corresponding to the purchase price,
confirming by the server the sale of the commodity by the vendor using the vendor account information and the purchase information,
sending sale confirmation information to the vendor from the server via the mobile phone for display on the visual display, and
presenting to the customer the pre-printed receipt corresponding to the transaction identifier so that the pre-printed receipt with the transaction identifier may subsequently be used by the customer for delivery of the commodity from the provider.

3. The method as recited in claim 2 wherein the server includes data storage to store data about the vendor and wherein the step of confirming includes authenticating the vendor account information by comparison to the data stored in the data storage.

4. The method as recited in claim 3 wherein the stored data includes information corresponding to the pre-printed receipts possessed by the vendor and wherein the step of authenticating further includes authenticating the unique transaction identifier transmitted to the server by the vendor by matching the unique transaction identifier to one of the pre-printed receipts in the data storage.

5. A method for confirming the purchase of a commodity such as a product or service by an anonymous customer from an e-commerce provider via an Internet server, the purchase being transacted between the customer and a vendor having access to the server via an web-enabled mobile phone with a visual display, the method comprising
upon the customer paying a purchase price for the commodity to the vendor, transmitting to the server by the vendor, via the mobile phone, both vendor account information and purchase information including the commodity and the purchase price,
confirming by the server the sale of the commodity by the vendor using the vendor account information and the purchase information,
sending sale confirmation information to the vendor from the server via the mobile phone for display on the visual display, and
capturing the sale confirmation information on the visual display using a camera.

6. The method as recited in claim 5 wherein the server includes data storage to store data about the vendor and wherein the step of confirming includes authenticating the vendor account information by comparison to the data stored in the data storage.

7. The method as recited in claim 6 wherein the stored data includes information corresponding to a pre-printed receipt possessed by the vendor, the receipt having a unique transaction identifier, and wherein the step of confirming includes authenticating the transaction identifier as transmitted to the server by the vendor by matching the transaction identifier to the corresponding pre-printed receipt in the data storage.

8. The method as recited in claim 5 wherein the camera is a component of a customer mobile phone and the step of capturing includes the step of taking a picture of the visual display using the camera of the customer mobile phone.

9. The method as recited in claim 5 wherein the camera is a stand-alone digital camera possessed by the customer and the step of capturing includes the step of taking a picture of the visual display using the digital camera.

10. The method as recited in claim 5 wherein the step of capturing further includes the step of taking a picture of the visual display using a digital camera possessed by the vendor, and further including printing the imaged captured by the digital camera for delivery to the customer.
